(19) United States
(12) Patent Application Publication
(10) Pub. No.: US 2004/0177164 A1
(43) Pub. Date: Sep. 9, 2004

(54) System and method for reclaiming transmit descriptors

(76) Inventors: Francesco DiMambro, San Jose, CA (US); Charles Suresh, Menlo Park, CA (US); Jian Huang, Bloomington, MN (US)

Correspondence Address: PARK, VAUGHAN & FLEMING LLP, 702 MARSHALL STREET, SUITE 310, REDWOOD CITY, CA, 94063, US

(21) Appl. No.: 10/374,836

(22) Filed: Feb. 25, 2003

(51) Int. Cl. G06F 15/16; G06F 9/46

(52) U.S. Cl. 709/250; 719/312

(57) ABSTRACT

A system and method for reclaiming descriptors in a separate process (e.g., thread) from one in which packets are posted to a descriptor ring. The packet-posting process need not be interrupted to reclaim used descriptors, thereby reducing the delay in transmitting packets through a communication interface. The descriptor reclamation process, which may execute on a separate processor from the packet-posting process, may remain quiescent as long as the ring is less than half full or there are no descriptors to reclaim. Then, both processes may operate in parallel.

### BACKGROUND

This invention relates to the fields of computer systems and electronic communications. More particularly, a system and methods are provided for reclaiming used descriptors in a transmit descriptor ring.

Many computer systems and communication devices (e.g., network interface circuits or NICs) use descriptor rings to exchange incoming and/or outgoing communications (e.g., packets). A descriptor ring is generally implemented as a circular queue of data structures (descriptors) that can be populated with information describing a communication (e.g., size, location in memory). For example, in the transmit direction, a computer system formats a descriptor for an outgoing communication. The communication device reads the descriptor, then retrieves and transmits the packet.

Because there are a limited number of descriptors in a transmit descriptor ring, they must be reclaimed and reused after the corresponding communications are transmitted. However, most device drivers for communication devices, or other processes for controlling the transmission of communications, perform descriptor reclaim in the “hot path.” That is, reclamation efforts are performed as part of the process of adding a descriptor for a new communication—either immediately before or immediately after configuring the descriptor. This necessarily delays the transmission of the communication, and therefore adds latency to the communication process.

Thus, there is a need for a system and method for performing descriptor reclamation in a manner that avoids delaying the transmission of a communication.

### SUMMARY

In one embodiment of the invention, a system and methods are provided for reclaiming descriptors in a transmit descriptor ring. In this embodiment, descriptor reclamation is performed by a separate process (e.g., thread) from the process in which packets are posted to the ring. The packet-posting process need not be interrupted to reclaim used descriptors, thereby reducing the delay in transmitting packets through a communication interface. The descriptor reclamation process, which may execute on a separate processor from the packet-posting process, may remain quiescent as long as the ring is less than half full or there are no descriptors to reclaim. Then, both processes may operate in parallel.

### DESCRIPTION OF THE FIGURES

FIG. 1 is a block diagram depicting a descriptor ring in accordance with an embodiment of the present invention.

FIG. 2 is a diagram illustrating the parallel operation of descriptor reclamation and descriptor posting, in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In an embodiment of the invention, a system and method are provided for improving the efficiency with which packets or other electronic communications are transmitted by a computer or communication system. More specifically, the reclamation of descriptors is moved out of the “hot path” of the process of transmitting a packet.

Thus, in one implementation of this embodiment, a first set of computer executable instructions (e.g., a thread, a process, a function) posts packets to a descriptor ring, while a second set of instructions initiates reclamation of used descriptors. The separate sets of instructions may be executed by different processors.

Reclaiming a descriptor used for passing a communication between a computer system and a communication device may involve tearing down a corresponding DMA (Direct Memory Access) mapping (e.g., virtual address to physical address) and freeing the descriptor for reuse with another communication.

Embodiments of the invention are described below as they may be implemented during the transmission of packets (or other communications) from a computer system through a communication device such as a NIC (Network Interface Circuit). Other embodiments, for implementation with devices other than NICs, may be readily derived from these descriptions.

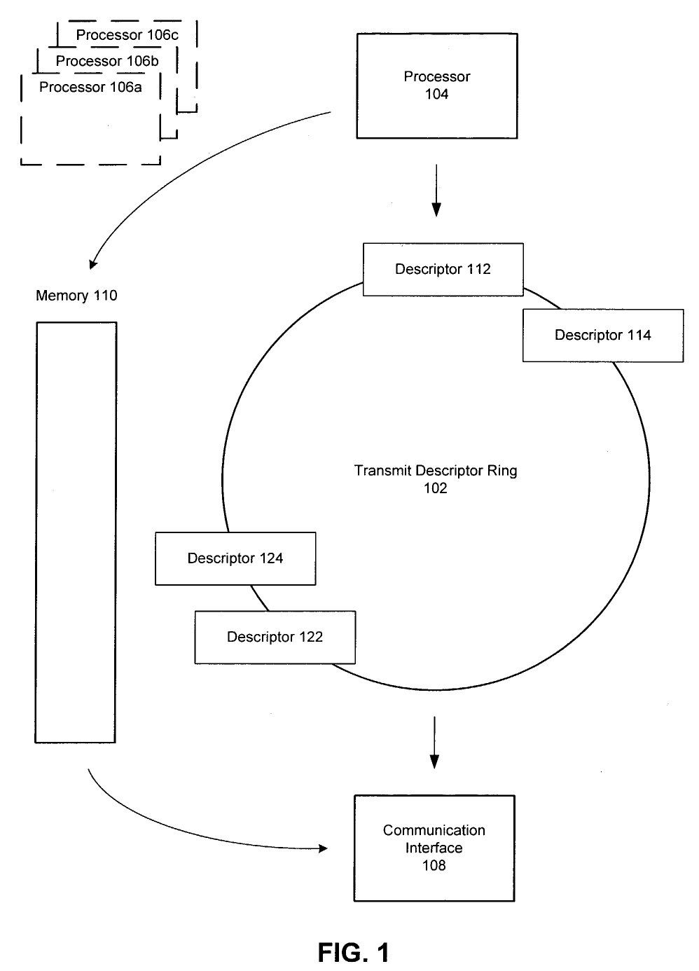

FIG. 1 demonstrates an illustrative descriptor ring with which an embodiment of the invention may be implemented. Transmit descriptor ring 102, comprising descriptors 112, 114, 122, 124, is used to facilitate the transfer of outgoing packets communication interface 108. In one implementation, descriptor ring 102 comprises approximately 256 descriptors.

Memory 110, part of the computer system that includes processor 104, is where packets are stored for transfer to the communication interface. In this embodiment, processor 104 (and/or optional processor(s) 106) and communication interface 108 are located in the same computer system, but may be part of different computing devices in an alternative embodiment.

When a packet is ready for transmission, processor 104 posts the packet to descriptor ring 102 by writing a descriptor (e.g., descriptor 112) with information regarding the packet. For example, the descriptor may be configured with the location, in memory 110, of the packet, the size of the packet, etc.

In the embodiment of FIG. 1, the process of posting a packet does not include the task of reclaiming descriptors associated with packets that have been transmitted and that can now be reused (e.g., descriptors 122, 124). Instead, a separate process (e.g., thread, method, function) is invoked, called or spawned to initiate reclamation. Thus, descriptor reclamation may be performed in parallel with packet posting.

Illustratively, the process of posting a packet may be initiated with a “wput” call (e.g., by a communication interface's device driver). The wput call causes a check as to whether there are any free descriptors on the ring. A descriptor may be considered free if it is not currently configured to identify or describe a packet. Each free descriptor is available to be configured, in turn, to facilitate the transfer of a corresponding packet to the communication interface.

As described above, a process other than wput is configured to perform descriptor reclamation and free descriptors for use by wput. In one embodiment of the invention, the separate process comprises a service thread provided by the Streams framework. In another embodiment, the communication interface's device driver spawns a reclaim thread or process for performing reclamation. Thus, the wput thread or process may execute on processor 104 in the embodiment of the invention depicted in FIG. 1, while the service or reclaim thread/process executes on another processor (e.g., processor 106a).

The service thread provided by the Streams framework (e.g., referred to herein as “wsrv”) is also configured to facilitate the queuing of packets for posting to a descriptor ring. Illustratively, when the ring is full (i.e., all descriptors are in use), wsrv queues packets in the order they are made available for posting. As descriptors are freed, they can be posted to the ring.

In an embodiment of the invention in which wsrv performs descriptor reclamation, wput is relieved of this function. An illustrative pseudo-code representation of the operative portion of this version of wsrv may be similar to the following:

reclaim
while (getq) {

post_tx_packet
if not (space_on_ring) {

qenable
exit

}

}

This version of wsrv invokes the reclaim process, which may operate in a manner known to those skilled in the art. For example, descriptors may be examined to determine if the communication interface has relinquished ownership of them, meaning that they may be reclaimed. Or, registers or other data structures within the communication interface may be accessed to determine which descriptors may be freed. In one implementation, Kick and Completion registers are read, which indicate which descriptors' packets have and have not been transmitted.

Illustratively, the space_on_ring function determines whether there are any free descriptors on the descriptor ring. The call to qenable re-schedules wsrv.

As described above, in another embodiment of the invention, a separate thread or process (e.g., “reclaim_thread”) is invoked or spawned by a communication interface's device driver, and may be bound to a particular processor (e.g., processor 106 of FIG. 1). For example, the device driver or operating system may determine which processor is handling most or all packet transmissions (e.g., the processor that receives packet interrupts), and bind reclaim_thread to a different processor.

The following is a sample pseudo-code representation of the operation portion of reclaim_thread:

while (running) {

if (ring_occupancy == 0)

wait (thread_handle)

reclaim

}

In this illustrative form, reclaim_thread comprises a while loop that keeps the thread in existence. In that loop, as long as there are no descriptors being used (i.e., ring_occupancy==0), there is nothing to reclaim and the thread can sleep. Otherwise, the reclaim process or function is initiated, which may operate as summarized above. The “thread_handle” is a handle for identifying reclaim_thread.

Thus, in illustrative embodiments of the invention, the invocation of the reclaim process is moved out of the hot path of packet transmission and into a different process or thread. The corresponding wput function may operate similar to the following pseudo-code:

if (space_on_ring) {

post_tx_packet
if (ring_occupancy) > 50% {

-- invocation of separate process --
qenable

< OR >

signal (thread_handle)

}

}

In this version of wput, packets are posted to a descriptor ring as long as there are packets and space on the ring. The process that invokes descriptor reclamation is not invoked until the ring is at least half full. Then, either wsrv is scheduled (i.e., by qenable) or reclaim_thread is signaled. If descriptor reclamation is performed by wsrv, then qenable is invoked. Otherwise, reclaim_thread is invoked via signal (thread_handle).

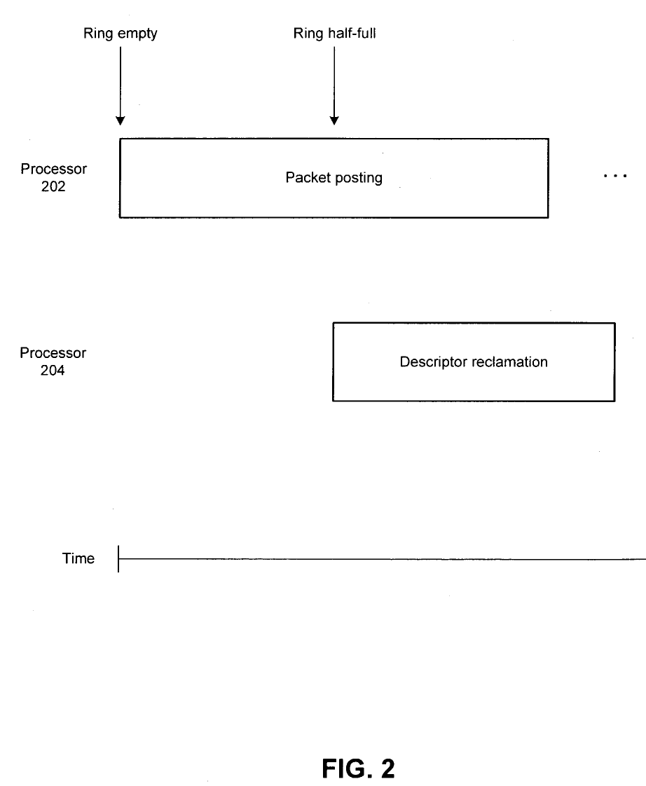

FIG. 2 demonstrates the parallel operation of packet posting and descriptor reclamation, according to one embodiment of the invention. FIG. 2 depicts two separate processes or threads, one for posting packets to a descriptor ring, and another for reclaiming descriptors from the ring.

A first processor (processor 202) executes the packet-posting thread, either continuously or as needed (e.g., as packets are ready to be transferred to a communication interface for transmission). A second processor (processor 204) starts reclaiming used descriptors (e.g., descriptors associated with packets that have been transmitted) after the ring is approximately half full. Both processes can then run in parallel, and packet processing is not delayed by the need to perform reclamation.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. A method of reclaiming descriptors in a descriptor ring for facilitating the transfer of packets to a communication device, the method comprising:
receiving a first packet for transmission from a computing device;
executing a first set of computer executable instructions configured to populate a first descriptor in a descriptor ring with information regarding the first packet, to facilitate transfer of the first packet to a communication device; and
if the number of populated descriptors in the descriptor ring exceeds a predetermined threshold, executing a second set of computer executable instructions configured to reclaim populated descriptors for reuse.

2. The method of claim 1, wherein:
said first set of computer executable instructions is executed on a first processor of the computing device; and
said second set of computer executable instructions is executed on a second processor of the computing device.

3. The method of claim 2, further comprising:
binding said second set of computer executable instructions to the second processor.

4. The method of claim 2, further comprising:
determining which of multiple processors in the computing device executes said first set of computer executable instructions.

5. A computer readable storage medium storing instructions that, when executed by a computer, cause the computer to perform a method of reclaiming descriptors in a descriptor ring for facilitating the transfer of packets to a communication device, the method comprising:
receiving a first packet for transmission from a computing device;
executing a first set of computer executable instructions configured to populate a first descriptor in a descriptor ring with information regarding the first packet, to facilitate transfer of the first packet to a communication device; and
if the number of populated descriptors in the descriptor ring exceeds a predetermined threshold, executing a second set of computer executable instructions configured to reclaim populated descriptors for reuse.

6. A method of reclaiming descriptors in a descriptor ring, the method comprising:
executing a first process for configuring a descriptor in a descriptor ring, to facilitate the transfer of a corresponding packet from a computer system to a communication device; and
in parallel with said first process, executing a second process for reclaiming descriptors in the descriptor ring after the corresponding packets are transmitted from the communication device.

7. The method of claim 6, wherein the computer system is a multiprocessor computer system.

8. The method of claim 6, wherein:
said first process is executed on a first processor of the multiprocessor computer system; and
said second process is executed on a second processor of the multiprocessor computer system.

9. The method of claim 8, further comprising:
determining which of multiple processors executes said first process.

10. A computer readable storage medium storing instructions that, when executed by a computer, cause the computer to perform a method for reclaiming descriptors in a descriptor ring, the method comprising:
executing a first process for configuring a descriptor in a descriptor ring, to facilitate the transfer of a corresponding packet from a multiprocessor computer system to a communication device; and
in parallel with said first process, executing a second process for reclaiming descriptors in the descriptor ring after the corresponding packets are transmitted from the communication device.

11. A computing device configured to reclaim descriptors in a descriptor ring for facilitating the transmission of packets from the computing device, the computer device comprising:
a memory configured to store packets for transfer from the computing device to a communication device for transmitting the packets;
a first process configured to post a packet to a descriptor ring by populating a descriptor in the descriptor ring; and
a second process configured to reclaim the descriptor after transmission of the packet by the communication device;
wherein said first process is distinct from said second process.

12. The computing device of claim 11, wherein:
the computing device comprises multiple processors;
said first process executes on a first processor of the multiple processors; and
said second process executes on a second processor of the multiple processors.

13. The computing device of claim 11, wherein said first process is configured to invoke said second process when a threshold number of descriptors in the descriptor ring are populated.

14. An apparatus for reclaiming descriptors in a descriptor ring, the apparatus comprising:
two or more processors;
a memory configured to store packets for transfer from a computing device toward a communication device configured to transmit the packets;
a first set of computer executable instructions configured to post a packet to a descriptor ring by populating a descriptor in the descriptor ring; and
a second set of computer executable instructions configured to reclaim the descriptor after transmission of the packet by the communication device;
wherein said first set of instructions and said second set of instructions execute in parallel.

15. The apparatus of claim 14, wherein said first set of instructions is executed by a first processor, and said second set of instructions is executed by a second processor.

16. The apparatus of claim 14, wherein said first set of instructions and said second set of instructions comprise separate threads of execution.

17. The apparatus of claim 16, wherein said first set of instructions comprises a device driver for the communication device.

18. The apparatus of claim 17, wherein said second set of instructions comprises a thread spawned by the device driver.

19. The apparatus of claim 14, wherein said second set of instructions comprises a service thread configured to queue packets for posting to the descriptor ring.

20. The computing device of claim 14, wherein said first set of instructions is configured to invoke said second set of instructions when a threshold number of descriptors in the descriptor ring are populated.
